(19) United States
(12) Patent Application Publication
(10) Pub. No.: US 2026/0070499 A1
(43) Pub. Date: Mar. 12, 2026

(54) SOUND-ABSORBING DEVICE AND VEHICLE

(71) Applicant: SONY GROUP CORPORATION, TOKYO (JP)

(72) Inventors: TAKEHIKO TANAKA, TOKYO (JP); FALK-MARTIN HOFFMANN, STUTTGART (DE)

(21) Appl. No.: 19/105,509

(22) PCT Filed: Jul. 25, 2023
(86) PCT No.: PCT/JP2023/027113

§ 371 Date: Feb. 21, 2025

(30) Foreign Application Priority Data
Aug. 31, 2022 (JP) 2022-138630

(51) Int. Cl. B60R 13/08; G10K 11/162; G10K 11/172

(52) U.S. Cl. CPC B60R 13/08; G10K 11/162; G10K 11/172

(57) ABSTRACT

Provided is, for example, a sound-absorbing device capable of coping with noise in various frequency bands and a vehicle to which the sound-absorbing device is applied. A sound-absorbing device includes a plurality of acoustic meta materials, each of the plurality of acoustic meta materials includes a plurality of sound-absorbing parts, and at least a first acoustic meta material and a second acoustic meta material out of the plurality of acoustic meta materials differ in target frequencies that are sound frequencies to be absorbed.

### TECHNICAL FIELD

The present disclosure relates to a sound-absorbing device and a vehicle.

### BACKGROUND ART

There are various types of noise such as engine noise, road noise, muffled noise, and wind noise propagating into a vehicle interior of an automobile.

For these types of noise, measures are implemented in consideration of frequencies specific to the noise. For example, for noise having a relatively low frequency such as engine noise, measures of disposing a vibration damping material around the engine are carried out.

Furthermore, for noise propagating through air in a vehicle interior (noise with frequencies spanning from the midrange to the wide range), measures of disposing a nonwoven fabric at an appropriate position in the vehicle interior are implemented. Furthermore, in Patent Document 1 described below, a technology of disposing a sound absorbing structure that absorbs a standing wave in a vehicle interior as measures against noise in the vehicle interior.

### CITATION LIST

### Patent Document

Patent Document 1: Japanese Patent Application Laid-Open No. 2021-15207

### SUMMARY OF THE INVENTION

### Problems to be Solved by the Invention

The sound absorbing structure described in Patent Document 1 has a problem that only noise in a predetermined frequency band can be absorbed. In general, the frequency band of noise propagating into a vehicle interior varies depending on a type, an arrival direction, and the like. Therefore, a sound-absorbing device capable of coping with noise in various frequency bands is desired.

An object of the present disclosure is to provide a sound-absorbing device capable of coping with noise in various frequency bands and a vehicle to which the sound-absorbing device is applied.

### Solutions to Problems

The present disclosure is, for example, a sound-absorbing device including
a plurality of acoustic meta materials, in which
each of the plurality of acoustic meta materials includes a plurality of sound-absorbing parts, and
at least a first acoustic meta material and a second acoustic meta material out of the plurality of acoustic meta materials differ in target frequencies that are sound frequencies to be absorbed.

The present disclosure is, for example, a vehicle including
a plurality of acoustic meta materials, in which
each of the plurality of acoustic meta materials includes a plurality of sound-absorbing parts, and
at least a first acoustic meta material and a second acoustic meta material out of the plurality of acoustic meta materials differ in target frequencies that are sound frequencies to be absorbed.

### BRIEF DESCRIPTION OF DRAWINGS

FIG. 1 is a diagram schematically illustrating a configuration example of a sound-absorbing device according to a first embodiment.

FIG. 2 is a diagram for explaining a configuration example of acoustic meta materials according to the first embodiment.

FIG. 3 is a diagram for explaining a configuration example of the acoustic meta materials according to the first embodiment.

FIG. 4 is a diagram for explaining a component of a sound-absorbing part according to the first embodiment.

FIG. 5A and FIG. 5B are diagrams for explaining cross-sectional shape examples of sound-absorbing parts according to the first embodiment.

FIG. 6 is a graph illustrating an example of a resonance frequency of each sound-absorbing part.

FIG. 7 is a graph using a theoretical formula for explaining that a high sound absorption factor can be obtained in a desired frequency band.

FIG. 8 is a graph using a simulation for explaining that a high sound absorption factor can be obtained in a desired frequency band.

FIG. 9 is a graph illustrating a sound absorption factor using a simulation of an acoustic meta material used in a sound absorption test.

FIG. 10 is a graph illustrating a sound absorption factor (actually measured value) of the acoustic meta material used in the sound absorption test.

FIG. 11 is a diagram for explaining an arrangement example of a sound-absorbing device according to a second embodiment.

FIG. 12 is a diagram referred to a case of describing changes in in-vehicle noise depending on the presence or absence of the sound-absorbing device according to the second embodiment.

FIG. 13 is a diagram illustrating an installation example of acoustic meta material groups on a vehicle according to a third embodiment.

FIG. 14A is a diagram for explaining an example of a sound pressure distribution corresponding to an acoustic mode 1, and FIG. 14B is a diagram for explaining an example of a sound pressure distribution corresponding to an acoustic mode 2.

FIG. 15A is a diagram for explaining an example of a sound pressure distribution corresponding to an acoustic mode 3, and FIG. 15B is a diagram for explaining an example of a sound pressure distribution corresponding to an acoustic mode 4.

FIG. 16A is a diagram for explaining an example of a sound pressure distribution corresponding to an acoustic mode 5, and FIG. 16B is a diagram for explaining an example of a sound pressure distribution corresponding to an acoustic mode 6.

FIG. 17 is a diagram illustrating an example of the frequency characteristics of sound in the vicinity of a driver's seat obtained by predetermined simulation.

FIG. 18 is a diagram for explaining a method of measuring noise propagating in a vehicle according to a fourth embodiment.

FIG. 19 is a diagram for explaining reference data for noise measured in the vehicle according to the fourth embodiment.

FIG. 20A and FIG. 20B are diagrams for explaining an example of the frequency characteristics of noise arriving from the roof section side of the vehicle according to the fourth embodiment.

FIG. 21A and FIG. 21B are diagrams for explaining an example of the frequency characteristics of noise arriving from the seat cushion side of the vehicle according to the fourth embodiment.

FIG. 22A and FIG. 22B are diagrams for explaining an example of the frequency characteristics of noise arriving from the windshield side of the vehicle according to the fourth embodiment.

FIG. 23A and FIG. 23B are diagrams for explaining an example of the frequency characteristics of noise arriving from the front right window of the vehicle according to the fourth embodiment.

FIG. 24A and FIG. 24B are diagrams for explaining an example of the frequency characteristics of noise arriving from the front left window of the vehicle according to the fourth embodiment.

FIG. 25 is a diagram illustrating an example of the frequency characteristics of noise arriving from the left A-pillar side of the vehicle according to the fourth embodiment.

FIG. 26 is a diagram illustrating an example of the frequency characteristics of noise arriving from the right A-pillar side of the vehicle according to the fourth embodiment.

FIG. 27 is a diagram illustrating an example of the frequency characteristics of noise arriving from the left B-pillar side of the vehicle according to the fourth embodiment.

FIG. 28 is a diagram illustrating an example of the frequency characteristics of noise arriving from the left A-pillar upper side of the vehicle according to the fourth embodiment.

FIG. 29 is a diagram illustrating an example of the frequency characteristics of noise arriving from the front left door trim of the vehicle according to the fourth embodiment.

FIG. 30 is a diagram illustrating an example of the frequency characteristics of noise arriving from the rear right window of the vehicle according to the fourth embodiment.

FIG. 31 is a diagram illustrating an example of the frequency characteristics of noise arriving from the left floor section side of the vehicle according to the fourth embodiment.

FIG. 32 is a diagram illustrating an example of the frequency characteristics of noise arriving from the center console side of the vehicle according to the fourth embodiment.

FIG. 33 is a diagram illustrating an example of the frequency characteristics of noise arriving from the headrest side of the vehicle according to the fourth embodiment.

### MODE FOR CARRYING OUT THE INVENTION

Hereinafter, an embodiment and the like of the present disclosure will be described with reference to the drawings. Note that the description will be given in the following order.
<First Embodiment>
<Second Embodiment>
<Third Embodiment>
<Fourth Embodiment>
<Modification>

The embodiments and the like described below are preferred specific examples of the present disclosure, and the content of the present disclosure is not limited to the embodiments and the like. Note that the sizes, the positional relationships of the members, and the like in the drawings may be exaggerated for clarity of description, and furthermore, there may be a case where only some of reference numerals are illustrated or the illustration is partially simplified in order to prevent the illustration from becoming complicated, or a case of omitting hatching of a cross section. Furthermore, in the description below, the same designations or the same reference numerals denote the same or similar members, and redundant descriptions will be omitted as appropriate. Furthermore, directions such as upward and downward directions, rightward and leftward directions, and the like are used for ease of explanation, but the present disclosure does not have the limitation to these directions in the description.

### First Embodiment

### Configuration Example of Sound-Absorbing Device

### Outline

First, a first embodiment will be described. The first embodiment is an embodiment relating to a sound-absorbing device having a plurality of acoustic meta materials. Here, a meta material means an artificially designed substance having a characteristic that does not exist in nature, and an acoustic meta material means a meta material for sound. The sound-absorbing device having the acoustic meta materials has high sound absorbing performance and can be made lighter than iron, glass, rubber, and the like.

In general, in-vehicle noise (for example, in-vehicle noise with 20 to 10,000 Hz as a frequency band) propagating into a vehicle interior tends to peak around 20 Hz and then decrease downward to the right. Regarding low-frequency in-vehicle noise (for example, 40 to 400 Hz) in such in-vehicle noise, the in-vehicle noise is canceled by known active noise cancellation that outputs a cancellation signal from a speaker. On the other hand, in-vehicle noise in a band of 200 to 1,000 Hz may not be sufficiently canceled by active noise cancellation. As will be described later, a target frequency that is a sound frequency to be absorbed can be adjusted by appropriately adjusting the configuration of the acoustic meta material included in the sound-absorbing device. By setting the target frequency to, for example, a frequency band in which the effectiveness of active noise cancellation is low (for example, 100 to 1,000 Hz), it is possible to effectively reduce in-vehicle noise. Hereinafter, a configuration example of the sound-absorbing device will be described in detail.

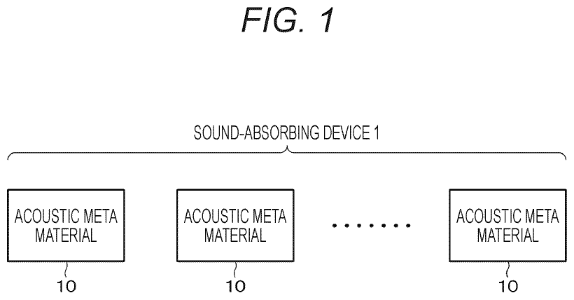

As schematically illustrated in FIG. 1, a sound-absorbing device 1 includes a plurality of acoustic meta materials (acoustic meta materials 10). In the present embodiment, a target frequency of a predetermined first acoustic meta material 10 out of the plurality of acoustic meta materials 10 is different from a target frequency of a second acoustic meta material 10 different from the first acoustic meta material 10. Note that, the fact that the target frequencies of the acoustic meta materials 10 are different from each other means that it is sufficient that the ranges of the target frequencies deviate from each other, and that the ranges of the target frequencies may all deviate from each other, or the ranges thereof may overlap partially with each other. Furthermore, out of the plurality of acoustic meta materials 10, acoustic meta materials 10 having the same target frequency as each other may exist.

### Configuration Example of Acoustic Meta Material

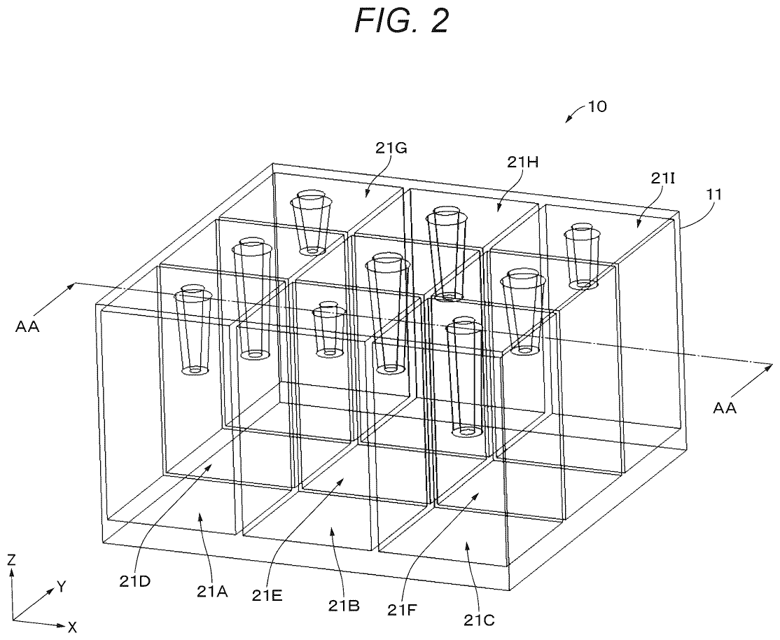

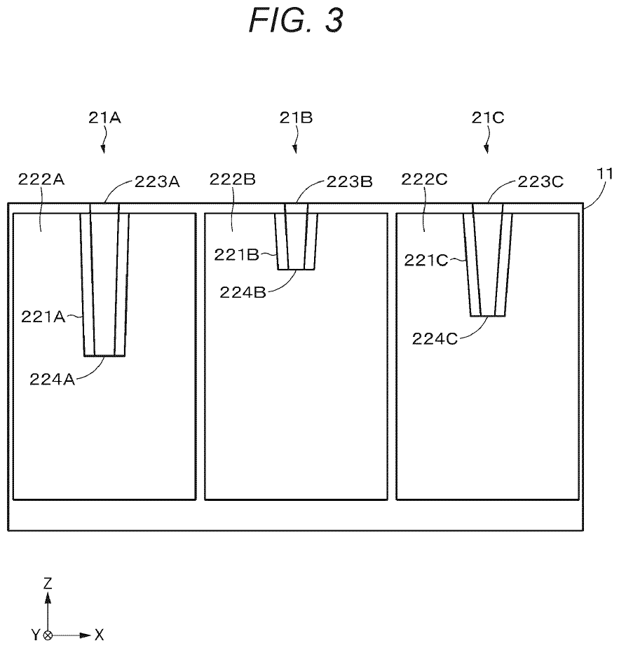

A configuration example of an acoustic meta material 10 included in the sound-absorbing device 1 will be described with reference to FIGS. 2 and 3. FIG. 2 is a diagram (perspective view) for explaining a configuration example of the acoustic meta material 10 included in the sound-absorbing device 1. FIG. 3 is a cross-sectional view illustrating a cross section in a case cutting the acoustic meta material 10 along cutting line AA-AA in FIG. 2.

The acoustic meta material 10 includes a box-shaped housing 11. The acoustic meta material 10 includes a plurality of sound-absorbing parts formed in the housing 11. The acoustic meta material 10 illustrated in FIG. 2 includes, for example, nine sound-absorbing parts 21A, 21B, 21C, . . . , and 21I. Note that, in a case where it is not necessary to distinguish the individual sound-absorbing parts, the individual sound-absorbing parts may be simply referred to as sound-absorbing parts 21. The nine sound-absorbing parts 21 are arranged in a matrix inside the housing 11, for example. Note that the number of the sound-absorbing parts 21 is an example, and may be other than nine.

Each sound-absorbing part 21 is formed as, for example, a Helmholtz resonator. Specifically, each sound-absorbing part 21 has a tubular neck portion whose both ends are open ends and a cavity portion, which is a closed space communicating with the neck portion.

Generally, a volume of the cavity portion is set larger than a volume of the neck portion. In a case where sound enters in the neck portion through an opening portion, air in the neck portion is pushed into the cavity portion, the pressure in the cavity portion is increased by the air pushed into the cavity portion, and the air is pushed back again. As these movements are repeated alternately, the Helmholtz resonator vibrates and sounds. The Helmholtz resonator has an effect of absorbing kinetic energy of sound around resonating sound (sound at a resonance frequency), and a sound-absorbing effect can be obtained by this effect.

As illustrated in FIG. 3, for example, the sound-absorbing part 21A includes a cylindrical tubular neck portion 221A and a cavity portion 222A that communicates with the neck portion 221A and is a closed space formed in the housing 11. The neck portion 221A includes a first opening portion 223A that is an open end to the outside of the housing 11 and a second opening portion 224A on the opposite side (disposed in the cavity portion 222A). The sound taken in from the first opening portion 223A is absorbed by the principle of Helmholtz resonance described above. Note that, in the present embodiment, the neck portion 221A has a cylindrical tubular shape, but may have another shape, for example, a triangular prism shape or a quadrangular prism shape. Furthermore, the first opening portion 223A and the second opening portion 224A may have a triangular shape or a quadrangular shape instead of a circular shape. Furthermore, in the present embodiment, the cavity portion 222A may have, for example, another box-like shape such as a spherical shape. However, from the viewpoint of arranging the plurality of sound-absorbing parts 21, the shape of the cavity portion 222A preferably has a cubic shape or a rectangular parallelepiped shape. The same applies to neck portions, cavity portions, first opening portions, and second opening portions included in other sound-absorbing parts 21.

Similarly, the sound-absorbing part 21B includes a cylindrical tubular neck portion 221B and a cavity portion 222B that communicates with the neck portion 221B and is a closed space formed in the housing 11. The neck portion 221B includes a first opening portion 223B that is an open end to the outside of the housing 11 and a second opening portion 224B on the opposite side (disposed in the cavity portion 222B). Furthermore, the sound-absorbing part 21C includes a cylindrical tubular neck portion 221C and a cavity portion 222C that communicates with the neck portion 221C and is a closed space formed in the housing 11. The neck portion 221C includes a first opening portion 223C that is an open end to the outside of the housing 11 and a second opening portion 224C on the opposite side (disposed in the cavity portion 222C). Note that, in a case where it is not necessary to distinguish the neck portions, the cavity portions, the first opening portions, and the second opening portions included in individual sound-absorbing parts 21, those are appropriately collectively referred to a neck portion 221, a cavity portion 222, a first opening portion 223, and a second opening portion 224.

The acoustic meta material 10 is obtained, for example, by molding a resin material with a 3D printer or a mold. However, the material of the acoustic meta material 10 is not limited to the resin. The material of the acoustic meta material 10 may be metal, wood, foam material, or the like. On the other hand, due to the installation in a vehicle or the like, the sound-absorbing device 1 including the acoustic meta material 10 preferably includes a material capable of achieving weight reduction. Note that the present applicant has already filed EP 22164643.3 A as a patent application including a Helmholtz resonator and an acoustic meta material having the Helmholtz resonator. The subject matter disclosed in the patent application are applicable to the present application.

### Characteristics of Sound-Absorbing Part

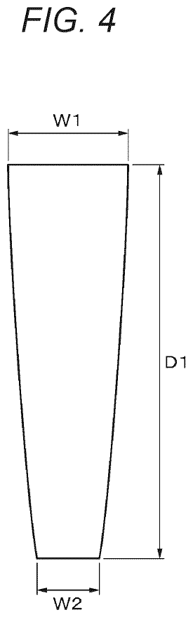

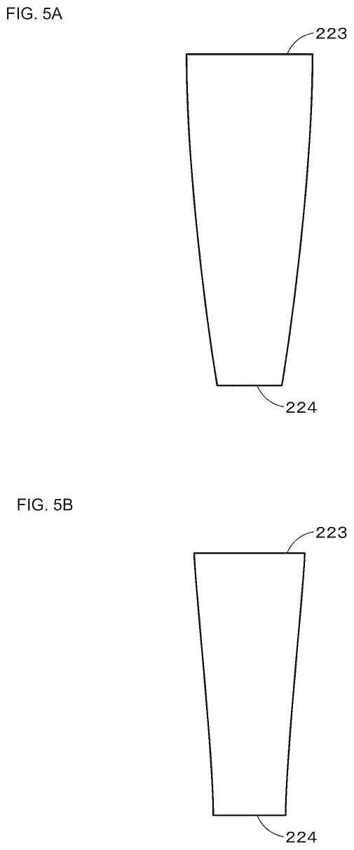

In the present embodiment, the resonance frequencies of the nine sound-absorbing parts 21 constituting the acoustic meta material 10 are slightly different from each other. As illustrated in FIG. 4, in the cross-sectional view of the sound-absorbing part 21, the length of the neck portion 221 is D1, the length of the diameter of the first opening portion is W1, and the length of the diameter of the second opening portion is W2. For example, as at least one of D1, W1, or W2 of each sound-absorbing part 21 is made different, the resonance frequency of each sound-absorbing part 21 can be made different. The cross-sectional shape of each sound-absorbing part 21 may be changed. For example, in a case where the sound-absorbing part 21 is viewed in a cross section as illustrated in FIG. 5A, the resonance frequency can be changed by forming the sound-absorbing part 21 in a convex tapered shape in which the shape formed from the first opening portion 223 to the second opening portion 224 is not straight but slightly curved convexly, or forming the sound-absorbing part 21 in a concave tapered shape in which the shape is curved to be slightly concave as illustrated in FIG. 5B.

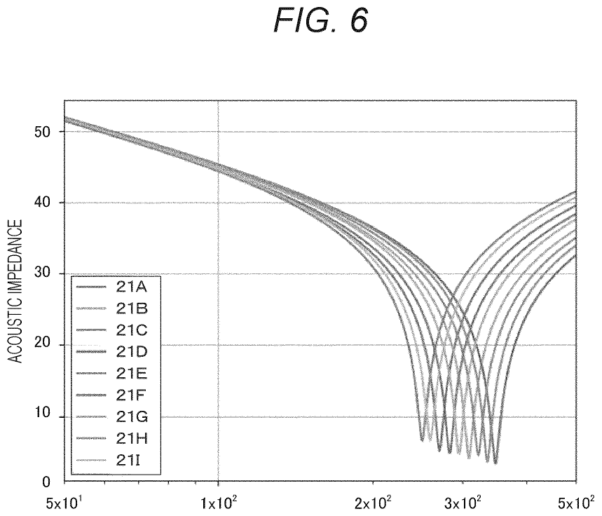

The graph of FIG. 6 illustrates an example of a resonance frequency of each sound-absorbing part 21. In the graph of FIG. 6, the horizontal axis represents frequency, and the vertical axis represents acoustic impedance, which represents ease of sound propagation. The position of a dip in each line illustrated in FIG. 6 corresponds to the resonance frequency of each sound-absorbing part 21. As described above, the resonance frequencies of the sound-absorbing parts 21A to 21I constituting the acoustic meta material 10 are slightly different from each other.

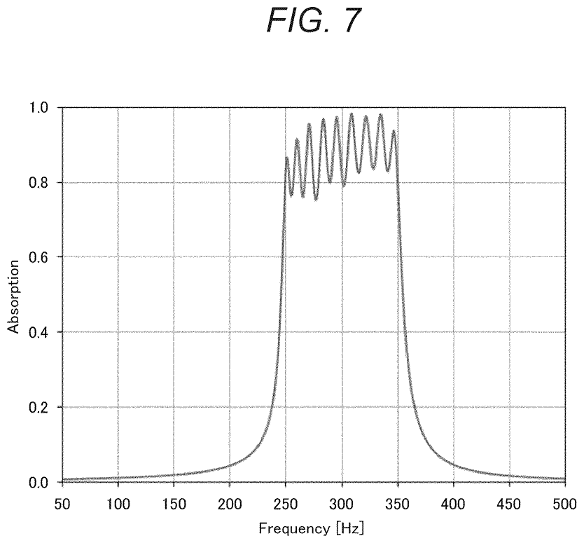

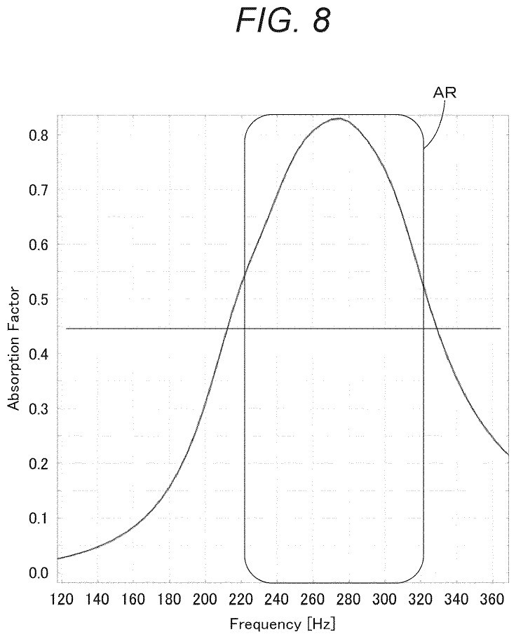

FIG. 7 is a graph of a resonance frequency obtained by applying the known theoretical formula for the Helmholtz resonator to each sound-absorbing part 21. In the graph of FIG. 7, the horizontal axis represents frequency, and the vertical axis represents sound absorption factor. The relationship between the resonance frequency and the sound absorption factor obtained through the acoustic simulation using a computer is represented by the graph illustrated in FIG. 8 in which the sound absorption characteristics of the sound-absorbing parts 21 are synthesized. In the graph of FIG. 8, the horizontal axis represents frequency, and the vertical axis represents sound absorption factor. As illustrated in the graphs of FIGS. 7 and 8, it is possible to achieve a high sound absorption factor in a necessary frequency band since the resonance frequencies of the sound-absorbing parts 21 slightly deviate from each other.

For example, according to the acoustic meta material 10 according to the present example, a sound absorption factor of 0.5 or higher is obtained in the frequency band (220 to 320 Hz) surrounded by a frame portion AR illustrated in the graph of FIG. 8, and moreover, a high sound absorption factor of 0.8 or higher is obtained in a range of 260 Hz to 280 Hz.

### Result of Sound Absorption Test

Next, the result of actually producing an acoustic meta material and performing a sound absorption test will be described. As the acoustic meta material, eight sound-absorbing parts in the vertical direction and eight sound-absorbing parts in the horizontal direction (64 pieces) are arranged in a housing (length of 15 cm, width of 15 cm, and height of 3 cm). As described above, the resonance frequencies of the 64 sound-absorbing parts were set to be slightly different from each other. The sound absorption factor of the produced acoustic meta materials was measured through the sound absorption test. As the sound absorption test, a known sound absorption test can be applied. In the present example, a cylindrical acoustic waveguide is prepared, and a speaker is arranged at an end. The produced acoustic meta materials are arranged at predetermined positions in an acoustic waveguide (on the propagation path of sound reproduced from the speaker), and microphones are arranged before and after the acoustic meta materials. Then, the test sound is reproduced from the speaker, the sound pressures of the test sound are measured by the microphones before and after the test sound passes through the arrangement positions of the acoustic meta materials, and the sound pressure loss is measured to obtain the sound absorption factor (vertical sound absorption factor). Note that target frequencies of the acoustic meta materials are set in the lowest frequency band (250 to 330 Hz) among target frequencies at which it is difficult to efficiently produce the acoustic meta materials.

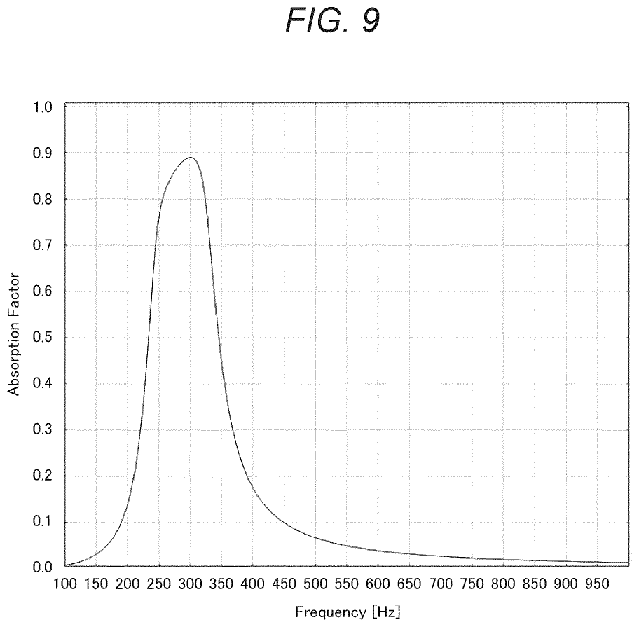

FIG. 9 illustrates a sound absorption factor obtained by a computer simulation for the produced acoustic meta materials. In the graph of FIG. 9, the horizontal axis represents frequency, and the vertical axis represents sound absorption factor. According to the computer simulation, it can be seen that the sound absorption factor of the acoustic meta materials within 250 Hz to 350 Hz of the target frequencies is as high as 0.8 or higher.

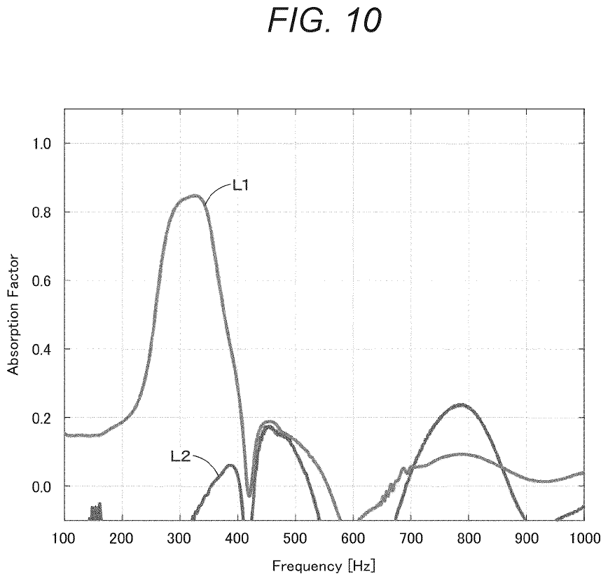

FIG. 10 Illustrates a Result (actually Measured value) of the sound absorption test. In the graph of FIG. 10, the horizontal axis represents frequency, and the vertical axis represents sound absorption factor. Furthermore, line L1 in FIG. 10 is the result of a sound absorption test in which the acoustic meta materials are arranged, and line L2 is the result of a sound absorption test in which the acoustic meta materials are not arranged. As illustrated in FIG. 10, in a case where line L1 and line L2 are compared with each other, it can be seen that line L1 has a higher sound absorption factor than that of line L2 in the range of the target frequencies. That is, it can be seen that a high sound absorption factor is obtained by the acoustic meta materials of the present embodiment. Furthermore, as indicated by line L1, it can be seen that substantially the same result as the simulation result (the sound absorption factor is substantially 0.8 or higher) is obtained within the range of the target frequencies.

As described above, according to the sound-absorbing device including the acoustic meta materials according to the present embodiment, it is possible to obtain a high sound absorption factor in a desired frequency band. Since the target frequencies of the acoustic meta materials can be appropriately set by adjusting the shape of the sound-absorbing parts, it is possible to cope with noise in various frequency bands.

### Second Embodiment

Next, a second embodiment will be described. Note that, in the description of the second embodiment, components that are identical or similar to those in the above embodiment are denoted by the same reference signs as those used in the above embodiment, and explanation of them is omitted herein as appropriate. Furthermore, the matters described in the first embodiment can be applied to the second embodiment unless otherwise specified. It similarly applies to other embodiments such as a third embodiment.

The second embodiment is an embodiment in which a sound-absorbing device is disposed in a vehicle. The sound-absorbing device (sound-absorbing device 1A) according to the second embodiment has substantially the same configuration as that of the sound-absorbing device 1 described in the first embodiment. That is, the sound-absorbing device 1A includes a plurality of acoustic meta materials 10. Specifically, the sound-absorbing device 1A according to the present embodiment has a configuration in which about 40 to 50 acoustic meta materials 10 are arranged. The acoustic meta materials 10 according to the present embodiment are configured such that eight sound-absorbing parts 21 in the vertical direction and eight sound-absorbing parts 21 in the horizontal direction (64 pieces) are arranged in a housing with a length of 15 cm, a width of 15 cm, and a height of 3 cm, for example. Similarly to the first embodiment, the resonance frequencies of the sound-absorbing parts 21 are slightly deviate from each other. Specifically, a shape of each of the sound-absorbing parts 21 was adjusted such that the target frequencies of the acoustic meta materials 10 are set within 250 to 350 Hz.

In the present embodiment, the sound-absorbing device 1A is arranged in the vehicle interior according to the simulation using a computer. Specifically, as illustrated in FIG. 11, a vehicle 30 having a predetermined shape is set, and the plurality of acoustic meta materials 10 included in the sound-absorbing device 1A according to the present embodiment are uniformly arranged on a roof section 31 of the vehicle 30. In FIG. 11, the sound-absorbing device 1A arranged in the vehicle 30 is shaded. Then, in-vehicle noise propagating in the vehicle 30 is then set in the computer, and changes in the in-vehicle noise depending on the presence or absence of the sound-absorbing device 1A are obtained by simulations.

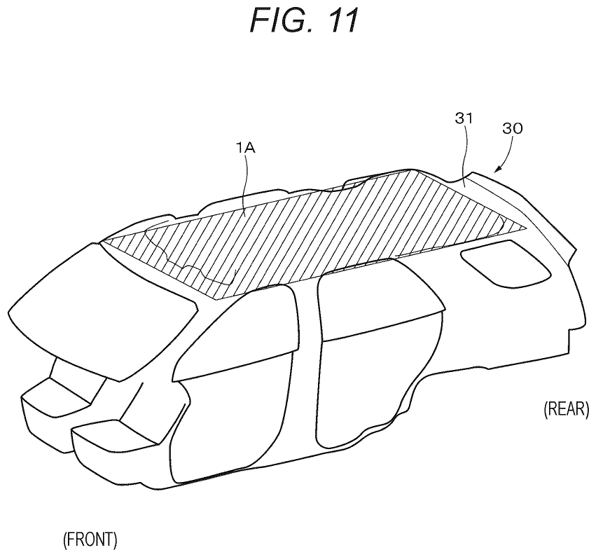

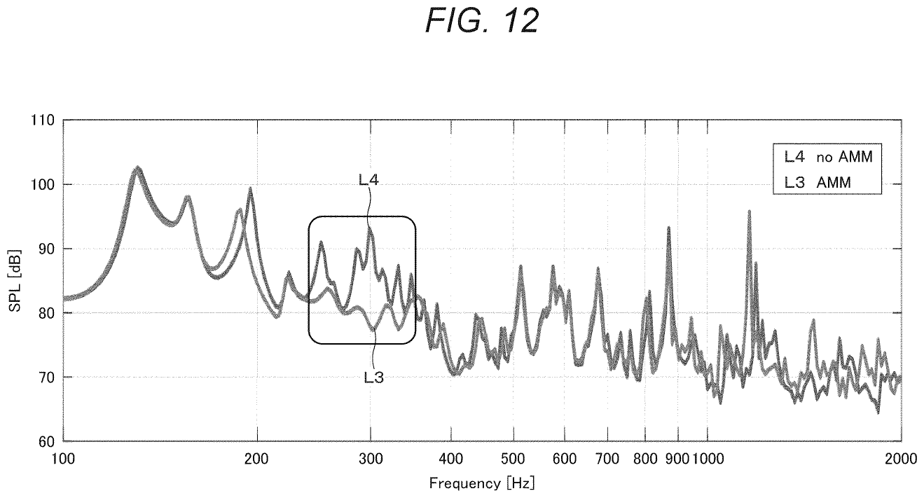

FIG. 12 illustrates the simulation results. In the graph of FIG. 12, the horizontal axis represents frequency, and the vertical axis represents sound pressure of the in-vehicle noise. Furthermore, line L3 in FIG. 12 indicates the simulation result in a case where the acoustic meta materials 10 are provided, that is, the sound-absorbing device 1A is arranged in the vehicle 30, and line L4 indicates the simulation result in a case where the acoustic meta materials 10 are not provided, that is, the sound-absorbing device 1A is not arranged in the vehicle 30.

As illustrated in FIG. 12, in a case where line L3 is compared with line L4 within 250 to 350 Hz of the target frequencies for the sound-absorbing device 1A, it can be seen that line L3 has a lower sound pressure of the in-vehicle noise. Specifically, in-vehicle noise of around 300 Hz has been reduced by about 10 dB. That is, by arranging the sound-absorbing device 1A having the plurality of acoustic meta materials 10 in the roof section 31 of the vehicle 30, it is possible to effectively reduce the in-vehicle noise propagating in the vehicle interior of the vehicle 30. Furthermore, although the in-vehicle noise in a frequency range of 250 to 350 Hz is in a frequency band that is difficult to be reduced by active noise cancellation, the sound-absorbing device 1A can effectively reduce the in-vehicle noise in the frequency band.

### Third Embodiment

A third embodiment is an embodiment in which a sound-absorbing device is installed in a vehicle similarly to the second embodiment. In the present embodiment, an acoustic meta material group consisting of a plurality of acoustic meta materials, which is included in a sound-absorbing device, is provided. As an acoustic meta material, the acoustic meta material 10 described in the first embodiment or an acoustic meta material having a similar configuration can be used. The present embodiment is an embodiment in which a plurality of acoustic meta material groups is not uniformly installed at predetermined positions of a vehicle, but is installed at separated positions of the vehicle 30. The acoustic meta material groups are built in predetermined positions of a constituent member (body) of the vehicle.

FIG. 13 is a diagram illustrating an installation example of acoustic meta material groups on the vehicle 30. For example, an acoustic meta material group 41A is installed in a roof section 31 of a vehicle 30. The acoustic meta material group 41A is installed in the roof section 31 such that first opening portions of acoustic meta materials constituting the acoustic meta material group 41A faces downward. The acoustic meta material group 41A has, for example, a configuration in which eight acoustic meta materials are arranged in the front-rear direction of the vehicle 30, six acoustic meta materials are arranged in the left-right direction of the vehicle 30, that is, a total of 48 acoustic meta materials are arranged in a matrix.

Furthermore, an acoustic meta material group 41B is installed in the upper section of a front door 32 of the vehicle 30. The acoustic meta material group 41B is installed in the upper section of the front door 32 such that first opening portions of acoustic meta materials constituting the acoustic meta material group 41B faces inward (vehicle interior side). Note that an acoustic meta material group having the same shape as the acoustic meta material group 41B is also installed in the upper section of a front door on the opposite side that is not illustrated in FIG. 13. The acoustic meta material group 41B has, for example, a configuration in which four acoustic meta materials are arranged in the front-rear direction of the vehicle 30, two acoustic meta materials are arranged in the vertical direction of the vehicle 30, that is, a total of eight acoustic meta materials are arranged in a matrix.

Furthermore, an acoustic meta material group 41C is installed in a lower section of the front door 32 of the vehicle 30. The acoustic meta material group 41C is installed in the trim of the front door 32 such that first opening portions of acoustic meta materials constituting the acoustic meta material group 41C faces inward (vehicle interior side). Note that an acoustic meta material group having the same shape as the acoustic meta material group 41C is also installed in the trim of a front door on the opposite side that is not illustrated in FIG. 13. The acoustic meta material group 41C has, for example, a configuration in which three acoustic meta materials are arranged in the front-rear direction of the vehicle 30, one acoustic meta material is arranged in the vertical direction of the vehicle 30, that is, a total of three acoustic meta materials are arranged in a matrix.

Furthermore, an acoustic meta material group 41D is installed in a rear door 33 of the vehicle 30. The acoustic meta material group 41D is installed in the rear door 33 such that first opening portions of acoustic meta materials constituting the acoustic meta material group 41D faces inward (vehicle interior side). Note that an acoustic meta material group having the same shape as the acoustic meta material group 41D is also installed in a rear door on the opposite side that is not illustrated in FIG. 13. The acoustic meta material group 41D has, for example, a configuration in which four acoustic meta materials are arranged in the front-rear direction of the vehicle 30, three acoustic meta materials are arranged in the vertical direction of the vehicle 30, that is, a total of 12 acoustic meta materials are arranged in a row.

Furthermore, an acoustic meta material group 41E is installed in a package tray 34 which is a flat portion behind the rear seats of the vehicle 30. The acoustic meta material group 41E is installed in the package tray 34 such that first opening portions of acoustic meta materials constituting the acoustic meta material group 41E faces upward (roof section 31 side). The acoustic meta material group 41E has, for example, a configuration in which two acoustic meta materials are arranged in the front-rear direction of the vehicle 30, six acoustic meta materials are arranged in the left-right direction of the vehicle 30, that is, a total of 12 acoustic meta materials are arranged in a matrix.

In general, in the vehicle interior, a standing wave is generated under the influence of a unique acoustic mode due to a shape of the vehicle, and a peak (antinode of the standing wave) or a dip (node of the standing wave) is generated in frequency characteristics at the driver's seat under the influence of the standing wave, for example. The frequency at which these peak and dip occur adversely affects the acoustic environment in the vehicle interior, including sound reproduction in the vehicle interior and in-vehicle noise.

The magnitude and frequency of the standing wave generated according to the acoustic mode at a predetermined position in the vehicle interior can be measured by simulations. FIG. 14A is a unique acoustic mode 1, specifically, a simulation result of the sound pressure distribution of the first-order standing wave propagating from the front to the rear of the vehicle 30. Reference numeral WN indicates a position corresponding to a node of the standing wave. From the simulation result illustrated in FIG. 14A, specifically, it can be seen that, as indicated by four black circles, the positions of the roof section over the front seats, and the position of the package tray, and the portion in the vicinity of the lower section thereof are positions that correspond to antinodes of the standing wave (positions where the sound pressure increases). By arranging the acoustic meta materials included in the sound-absorbing device at these positions, it is possible to reduce an adverse effect caused by the standing wave.

FIG. 14B is a unique acoustic mode 2, specifically, a simulation result of the sound pressure distribution of the first-order standing wave propagating in the left-right direction of the front seat of the vehicle 30.

Similarly to FIG. 14A, reference numeral WN indicates a position corresponding to a node of the standing wave.

From the simulation result illustrated in FIG. 14B, specifically, it can be seen that, as indicated by three black circles, the positions of the roof section above the front seats (excluding around the center) and the position in the vicinity of the front door are positions that correspond to antinodes of the standing wave (positions where the sound pressure increases). By arranging the acoustic meta materials included in the sound-absorbing device at these positions, it is possible to reduce an adverse effect caused by the standing wave.

FIG. 15A is a unique acoustic mode 3, specifically, a simulation result of the sound pressure distribution of the second-order standing wave propagating from the front to the rear of the vehicle 30. Similarly to FIG. 14A and the like, reference numeral WN (two positions) indicates a position corresponding to a node of the standing wave. From the simulation result illustrated in FIG. 15A, specifically, it can be seen that, as indicated by four black circles, the positions of the floor section of the front seats, of the roof section above the rear seats, in the vicinity of the trim of the rear door, and in the vicinity of the lower section of the rear of the vehicle 30 are positions that correspond to antinodes of the standing wave (positions where the sound pressure increases). By arranging the acoustic meta materials included in the sound-absorbing device at these positions, it is possible to reduce an adverse effect caused by the standing wave.

FIG. 15B is a unique acoustic mode 4, specifically, a simulation result of the sound pressure distribution of the first-order standing wave propagating in the vertical direction of the front seat of the vehicle 30. Similarly to FIG. 14A and the like, reference numeral WN (two positions) indicates a position corresponding to a node of the standing wave. From the simulation result illustrated in FIG. 15B, specifically, it can be seen that, as indicated by two black circles, the positions of the floor section of the front seats and in the vicinity of the roof section are positions that correspond to antinodes of the standing wave (positions where the sound pressure increases). By arranging the acoustic meta materials included in the sound-absorbing device at these positions, it is possible to reduce an adverse effect caused by the standing wave.

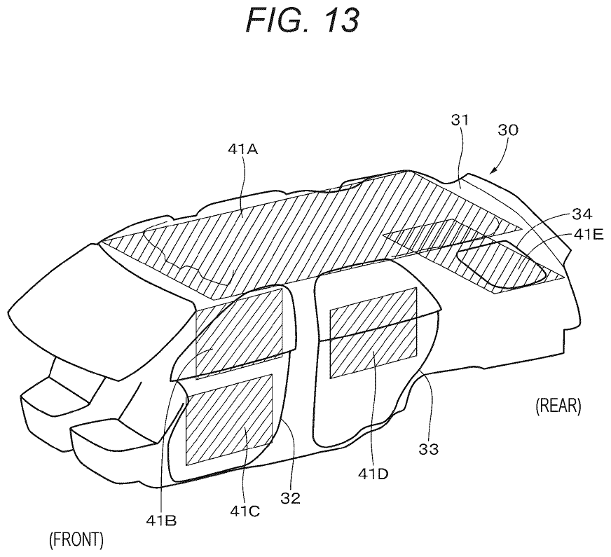

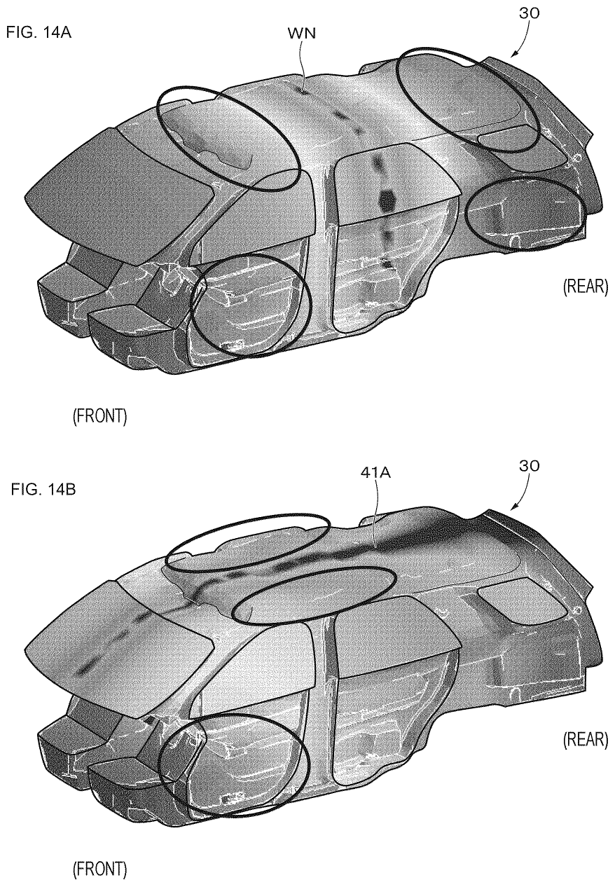

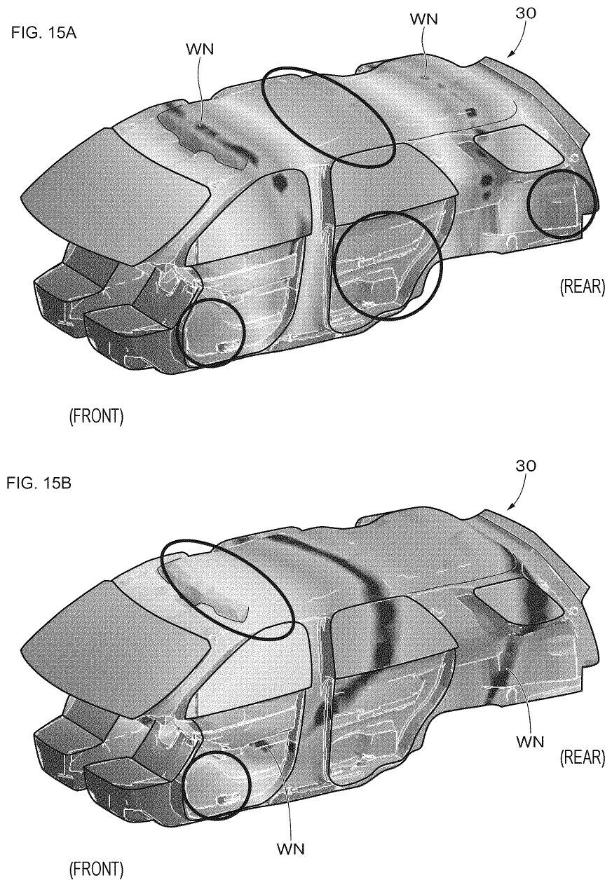

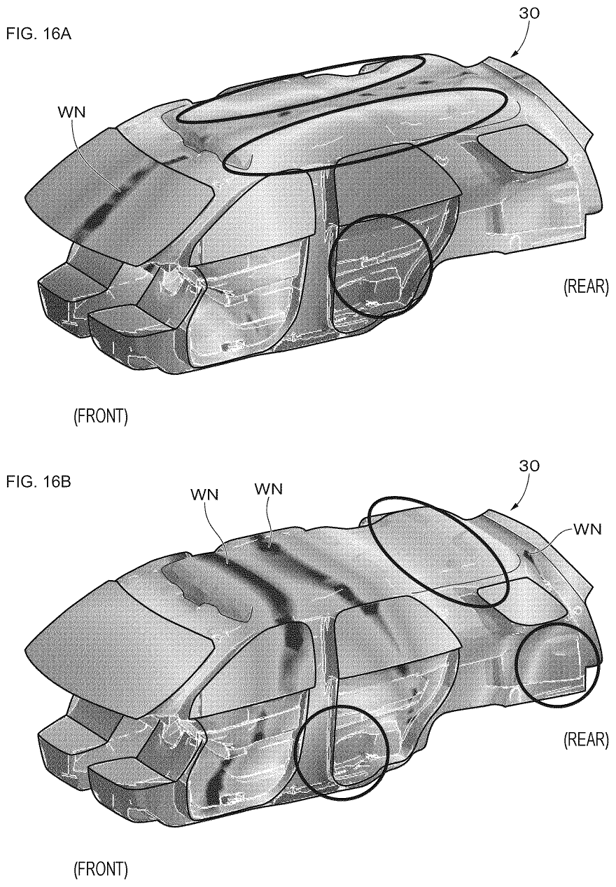

FIG. 16A is a unique acoustic mode 5, specifically, a simulation result of the sound pressure distribution of the first-order standing wave propagating in the left-right direction of the rear seats of the vehicle 30. Similarly to FIG. 14A and the like, reference numeral WN indicates a position corresponding to a node of the standing wave. From the simulation result illustrated in FIG. 16A, specifically, it can be seen that, as indicated by three black circles, the positions of the roof section above the rear seats and the area behind the rear seats (excluding around the center) and the position in the vicinity of the rear door are positions that correspond to antinodes of the standing wave (positions where the sound pressure increases). By arranging the acoustic meta materials included in the sound-absorbing device at these positions, it is possible to reduce an adverse effect caused by the standing wave.

FIG. 16B is a unique acoustic mode 6, specifically, a simulation result of the sound pressure distribution of the third-order standing wave propagating from the front to the rear of the vehicle 30. Similarly to FIG. 14A and the like, reference numeral WN (three positions) indicates a position corresponding to a node of the standing wave. From the simulation result illustrated in FIG. 16B, specifically, it can be seen that, as indicated by three black circles, the positions of the floor section of the rear seats, and the positions of the roof section above the area behind the rear seats and in the vicinity of the lower section thereof are positions that correspond to antinodes of the standing wave (positions where the sound pressure increases). By arranging the acoustic meta materials included in the sound-absorbing device at these positions, it is possible to reduce an adverse effect caused by the standing wave.

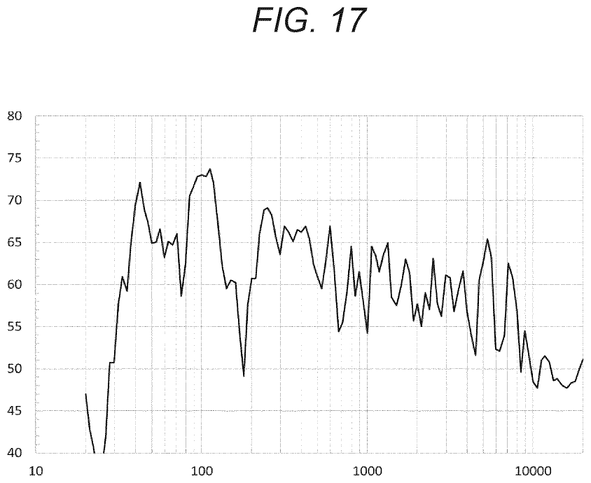

Furthermore, the frequency of the standing wave can also be measured by simulations. The graph in FIG. 17 illustrates an example of the frequency characteristic of the sound measured on the front seat (for example, on the driver's seat side). In FIG. 17, the horizontal axis represents frequency, and the vertical axis represents sound pressure. The graph illustrated in FIG. 17 is a result obtained by combining the frequency characteristics of the sound measured at the driver's seat during the simulations in the acoustic modes 1 to 6 described above.

As described above, unlike a general sound absorbing material, the acoustic meta material (for example, the acoustic meta material 10) according to the present disclosure can be set with any frequency range as a target frequency. That is, as in the second embodiment, the acoustic meta materials having the same target frequency are not uniformly installed, but the acoustic meta materials having the frequencies of the standing wave as the target frequencies are installed at the positions corresponding to the antinodes of the amplitude (the positions surrounded by black circles in FIGS. 14 to 16), so that the efficient standing wave resolution can be achieved.

For example, for the driver's seat, acoustic meta materials having target frequencies at around 200 to 450 Hz are installed in the roof section 31 over the driver's seat and in the vicinity of the front door 32. Furthermore, for example, it is assumed that the sound pressure of a 150 to 300 Hz sound increases in the vicinity of the roof section 31 over the rear seats and the rear door 33 by a simulation, in other words, the positions thereof are the antinodes of the standing wave. In this case, acoustic meta materials targeting around 150 to 300 Hz are installed in the roof section 31 over the rear seats, or acoustic meta materials targeting around 150 to 300 Hz are installed in the rear door 33.

As a result, it is possible to effectively reduce an adverse effect caused by the standing wave propagating in the vehicle interior of the vehicle 30.

### Fourth Embodiment

The present embodiment is an embodiment in which the acoustic meta materials or the acoustic meta material groups are provided at the positions corresponding to the arrival direction of noise in the vehicle. For example, the acoustic meta materials, each having a frequency of noise and a target frequency according to the sound pressure for each frequency, or the acoustic meta material groups, each having the plurality of acoustic meta materials, are provided at the positions corresponding to the arrival direction of the noise. Here, the arrival direction, frequency, and sound pressure of the noise can be obtained by measurement. The measurement may be a simulation using a computer, or may be a measurement in which a vehicle actually travels. In the present embodiment, the description will be given on the assumption that the arrival direction, frequency, and sound pressure of the noise are obtained by measurement in which the vehicle travels.

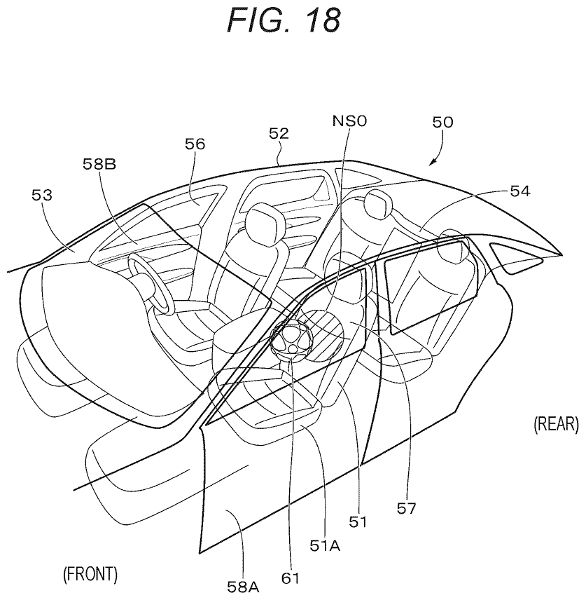

For example, as illustrated in FIG. 18, a microphone 61 is installed at a position of a passenger seat in a vehicle 50. The microphone 61 has a configuration in which multichannel (for example, 19 channels) microphones are arranged radially on a surface of a spherical housing. The arrival direction of noise can be distinguished by a position of each microphone.

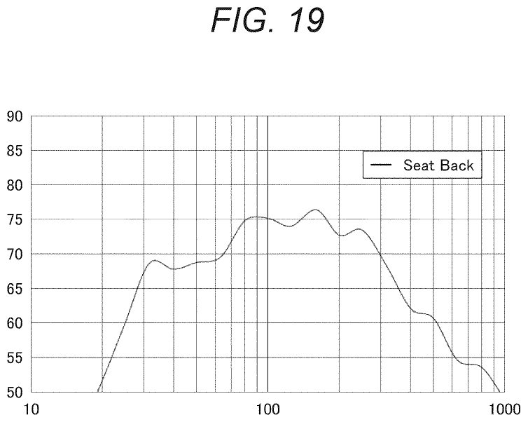

In the measurement, one-third octave band characteristics of a noise NS0 in a seat-back direction (the arrival direction from a rear seat 51) with the lowest noise level among the levels of noise measured with all the microphones of 19 channels were used as a reference. In FIG. 18, the noise NS0 schematically illustrated is shaded. FIG. 19 illustrates the frequency characteristics of the noise NS0 set as the reference. In FIG. 19, the horizontal axis represents frequency, and the vertical axis represents sound pressure. The frequency characteristics of the reference are values lower by about 30 dB at 1 KHz or more with 80 to 250 Hz as a peak. Note that the microphones used in this measurement do not use data of 80 Hz or less because the characteristics of 80 Hz or less are inaccurate due to reduced sensitivity.

FIG. 20A is a diagram schematically illustrating a noise NS1 arriving from the roof section 52 side of the vehicle 50. Furthermore, FIG. 20B illustrates the frequency characteristics of noise acquired by the microphones of the microphone 61 facing upward, that is, the frequency characteristics of the noise NS1 arriving from the roof section 52 side of the vehicle 50. The solid line in FIG. 20B indicates the frequency characteristics of the noise NS1 arriving from the roof section 52 side, and the dotted line indicates the frequency characteristics of the reference. As can be seen from FIG. 20B, the sound pressure of the noise NS1 arriving from the roof section 52 side increases by 1 to 2 dB within a range of 100 to 400 Hz.

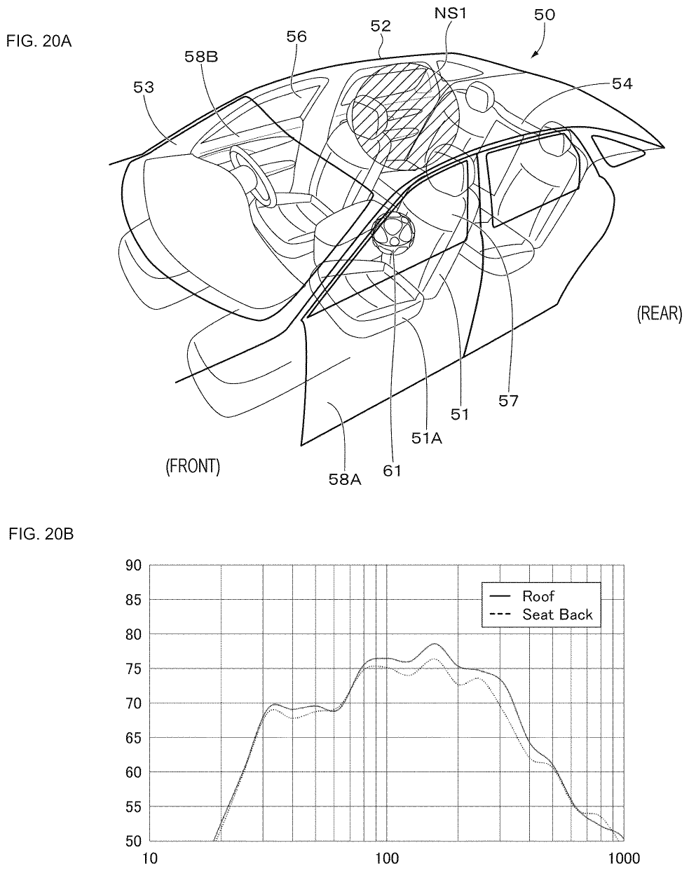

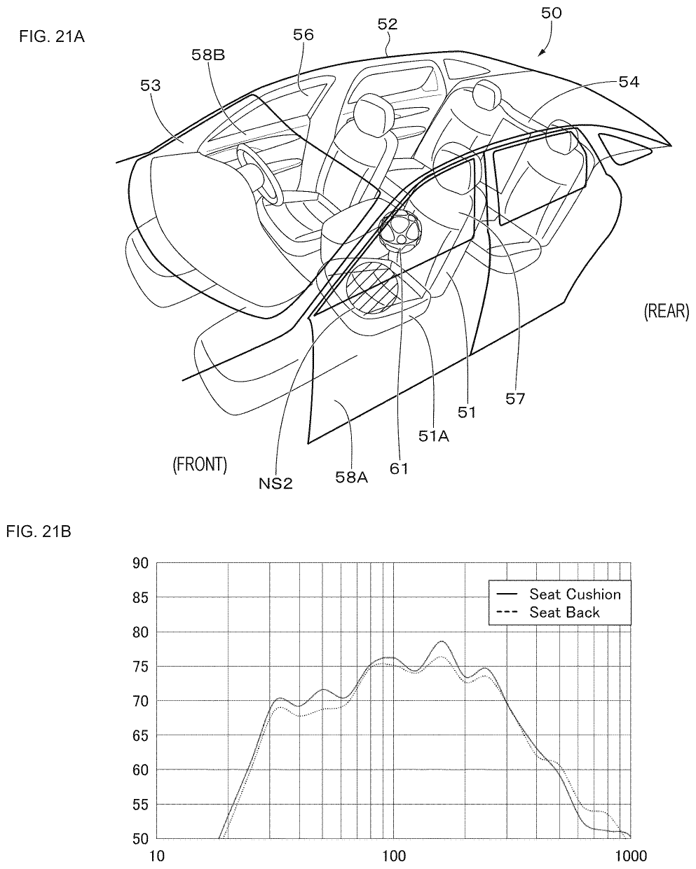

FIG. 21A is a diagram schematically illustrating a noise NS2 arriving from the seat cushion 51A side of the rear seat 51 of the vehicle 50. FIG. 21B illustrates the frequency characteristics of noise acquired by the microphones of the microphone 61 facing downward, that is, the frequency characteristics of the noise NS2 arriving from the seat cushion 51A side of the rear seat 51. The solid line in FIG. 21B indicates the frequency characteristics of the noise NS2 arriving from the seat cushion 51A side, and the dotted line indicates the frequency characteristics of the reference. As can be seen from FIG. 21B, the sound pressure of the noise NS2 arriving from the seat cushion 51A side increases by 1 to 2 dB within a range of 150 to 250 Hz with respect to the reference.

The noise NS1 arriving from the roof section 52 side is reflected by the seat cushion 51A or the like and reaches an acoustic meta material (actually, the acoustic meta material group including the plurality of acoustic meta materials) installed in the roof section 52. Furthermore, the noise NS2 arriving from the seat cushion 51A side reaches an acoustic meta material installed in the roof section 52. Therefore, the acoustic meta material to be installed in the roof section 52 of the vehicle 50 is determined using the measurement results illustrated in FIGS. 20B and 21B. That is, from the measurement results of FIGS. 20B and 21B, the acoustic meta material having a frequency band (for example, 150 to 250 Hz) including a frequency band having a large difference from the reference as a target frequency is installed in the roof section 52 of the vehicle 50.

FIG. 22A is a diagram schematically illustrating a noise NS3 arriving from the windshield 53 side of the vehicle 50. FIG. 22B illustrates the frequency characteristics of noise acquired by the microphones of the microphone 61 facing the windshield 53 side, that is, the frequency characteristics of the noise NS3 arriving from the windshield 53 side. The solid line in FIG. 22B indicates the frequency characteristics of the noise NS3, and the dotted line indicates the frequency characteristics of the reference. As can be seen from FIG. 22B, the sound pressure of the noise NS3 increases by 3 to 5 dB within a range of 150 to 400 Hz with respect to the reference.

The noise NS3 arriving from the windshield 53 side reaches an acoustic meta material installed in the package tray 54. Therefore, the acoustic meta material to be installed in the package tray 54 of the vehicle 50 is determined using the measurement result illustrated in FIG. 22B. That is, from the measurement result of FIG. 22B, the acoustic meta material having a frequency band (for example, 150 to 400 Hz) including a frequency band having a large difference from the reference as a target frequency is installed in the package tray 54.

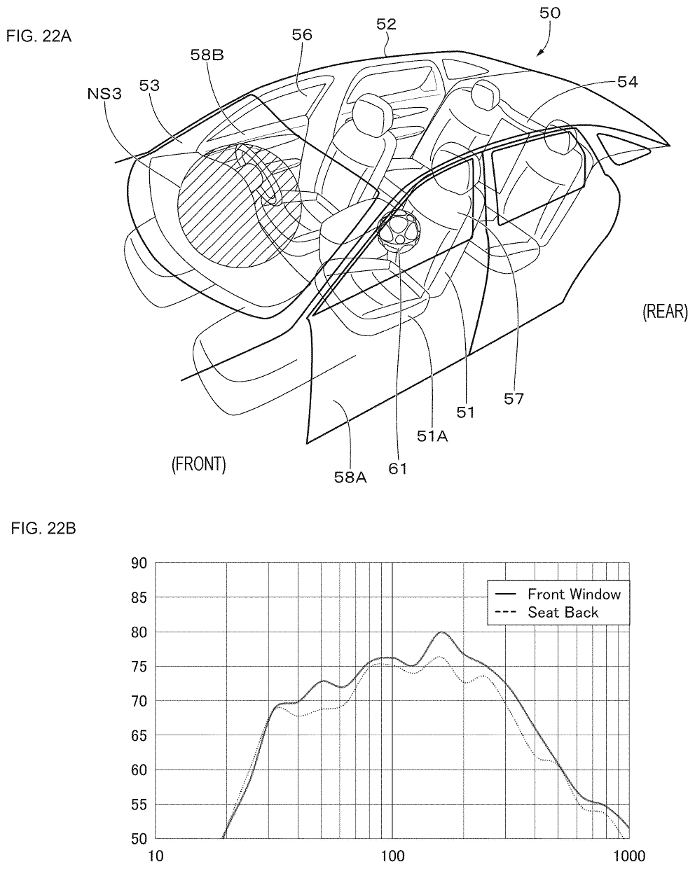

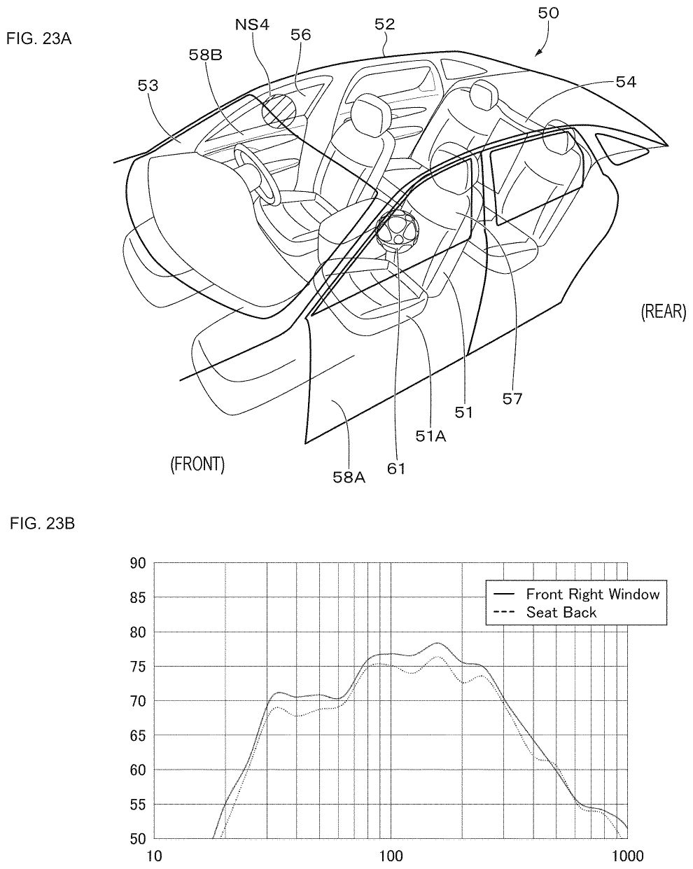

FIG. 23A is a diagram schematically illustrating a noise NS4 arriving from the front right window 56 side of the vehicle 50. Furthermore, FIG. 23B illustrates the frequency characteristics of noise acquired by the microphones of the microphone 61 facing the right side, that is, the frequency characteristics of the noise NS4 arriving from the front right window 56 side of the vehicle 50. The solid line in FIG. 23B indicates the frequency characteristics of the noise NS4 arriving from the right window 56 side, and the dotted line indicates the frequency characteristics of the reference. As can be seen from FIG. 23B, the sound pressure of the noise NS4 arriving from the front right window 56 side increases by 1 to 2 dB within a range of 100 to 400 Hz with respect to the reference.

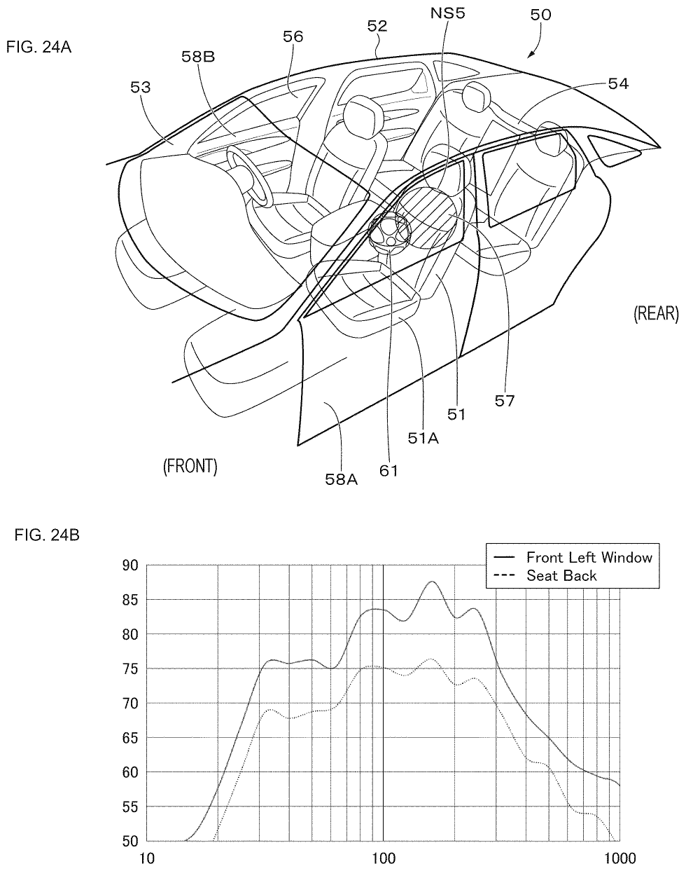

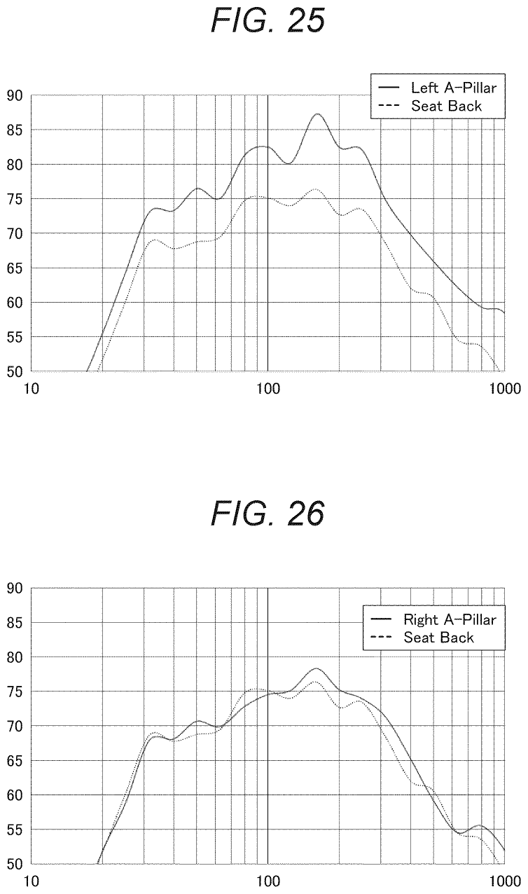

FIG. 24A is a diagram schematically illustrating a noise NS5 arriving from the front left window 57 side of the vehicle 50. Furthermore, FIG. 24B illustrates the frequency characteristics of noise acquired by the microphones of the microphone 61 facing the left side, that is, the frequency characteristics of the noise NS5 arriving from the front left window 57 side of the vehicle 50. The solid line in FIG. 24B indicates the frequency characteristics of the noise NS5 arriving from the front left window 57 side, and the dotted line indicates the frequency characteristics of the reference. As can be seen from FIG. 25B, the sound pressure of the noise NS4 arriving from the front left window 57 side increases by 5 to 10 dB almost over the entire range with respect to the reference.

Reflection components of the noise NS4 and the noise NS5 reach the acoustic meta material installed in the left front door 58A. Furthermore, the reflection components of the noise NS4 and the noise NS5 also reach the acoustic meta materials installed in the left front door 58B. Therefore, the acoustic meta material to be installed in each of the front door 58A and the front door 58B is determined using the measurement results illustrated in FIGS. 23B and 24B. That is, from the measurement results of FIGS. 23B and 24B, the acoustic meta material having a frequency band (for example, 200 to 500 Hz) including a frequency band difficult to obtain the effect of active noise cancellation and having a large difference from the reference as a target frequency is installed in each of the front door 58A and the front door 58B.

As described above, by installing the acoustic meta materials having the target frequencies suitable for absorbing the noise at the positions corresponding to the arrival direction of the noise propagating into the vehicle interior, specifically, at the positions to which the noise propagates, it is possible to reduce the in-vehicle noise including the components other than the standing wave and to effectively improve the sound field environment in the vehicle interior.

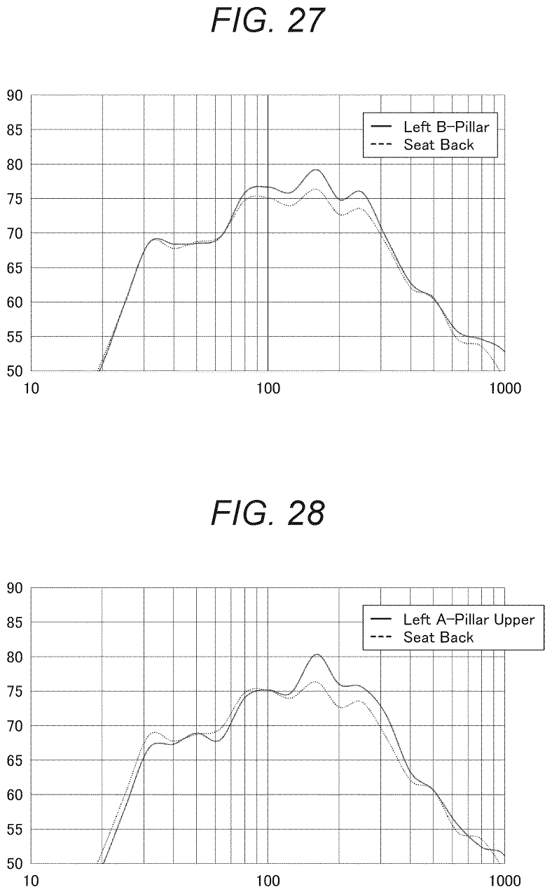

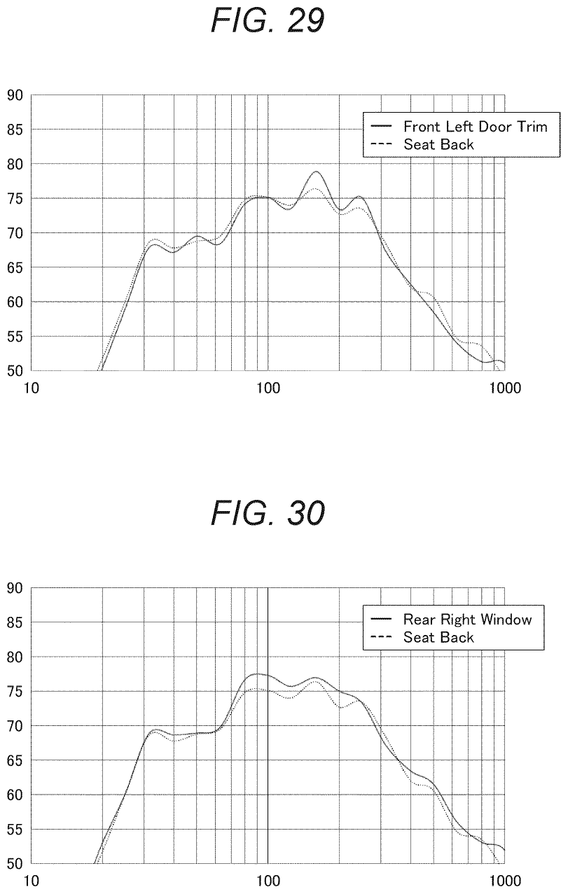

In consideration of the target frequencies of the acoustic meta materials, data other than the above-described measurement data may be used. FIG. 25 illustrates the frequency characteristics of noise arriving from the left A-pillar side. FIG. 26 illustrates the frequency characteristics of noise arriving from the right A-pillar side. FIG. 27 illustrates the frequency characteristics of noise arriving from the left B-pillar side. FIG. 28 illustrates the frequency characteristics of noise arriving from the left A-pillar upper side. FIG. 29 illustrates the frequency characteristics of noise arriving from the lower section (door trim) of the left front door 58A. In consideration of at least one of the frequency characteristics of the noise illustrated in FIGS. 25 to 29, an acoustic meta material having a target frequency capable of effectively absorbing the noise having the frequency characteristics considered may be installed in the front door 58A or the like.

Furthermore, FIG. 30 illustrates the frequency characteristics of noise arriving from the rear right window side. An acoustic meta material having a target frequency at which noise having the frequency characteristics can be effectively absorbed may be installed in the rear door.

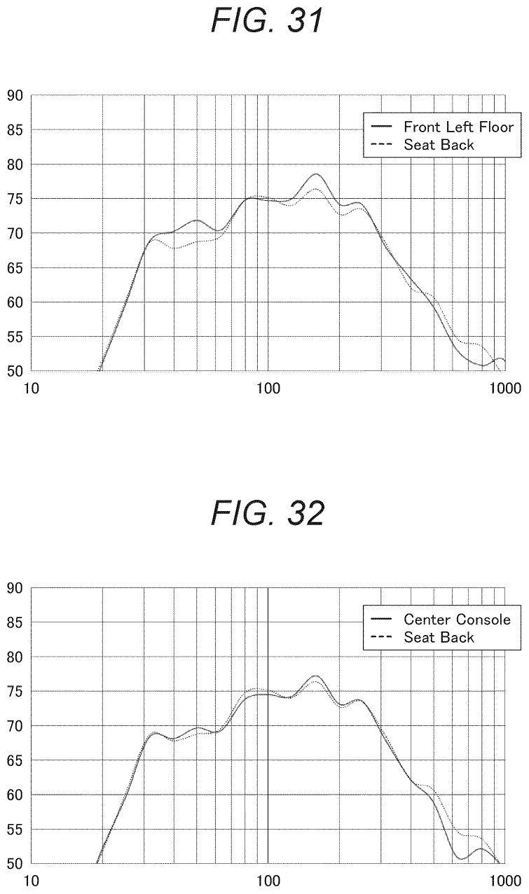

Furthermore, FIG. 31 illustrates the frequency characteristics of noise arriving from the front left floor section side. Furthermore, FIG. 32 illustrates the frequency characteristics of noise arriving from the center console side. In consideration of at least one of the frequency characteristics of the noise, an acoustic meta material having a target frequency capable of effectively absorbing the noise having the frequency characteristics considered may be installed in the roof section 52.

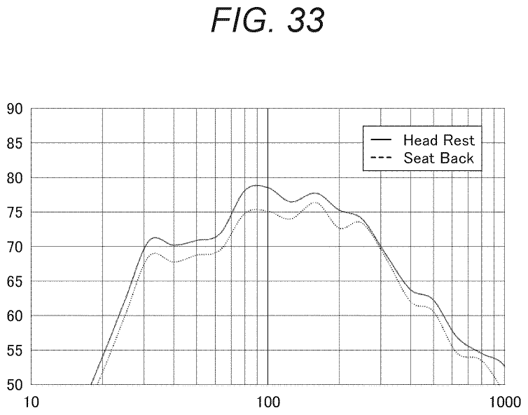

Furthermore, FIG. 33 illustrates the frequency characteristics of noise arriving from the headrest side. An acoustic meta material may be installed on, for example, a dashboard such that the noise having the frequency characteristics can be effectively absorbed. Specifically, the acoustic meta material having a target frequency at which the noise having the frequency characteristics illustrated in FIG. 33 can be effectively absorbed may be installed on the dashboard.

### Modification

Although the embodiment of the present disclosure has been specifically described above, the content of the present disclosure is not limited to the above-described embodiment, and various modifications based on the technical idea of the present disclosure are possible.

In the above-described embodiments, the examples in which the sound-absorbing device is mainly applied to the vehicle has been described, but the sound-absorbing device according to the present disclosure can be applied not only to the vehicle but also to a closed space such as a listening room or a movie theater.

The configurations, methods, steps, shapes, materials, numerical values, and the like described in the above embodiments are merely examples, and different configurations, methods, steps, shapes, materials, numerical values, and the like may be used as necessary. The above embodiments and modification can be appropriately combined.

The present disclosure may have the following configurations.

(1)
A sound-absorbing device including:
a plurality of acoustic meta materials, in which
each of the plurality of acoustic meta materials includes a plurality of sound-absorbing parts, and
at least a first acoustic meta material and a second acoustic meta material out of the plurality of acoustic meta materials differ in target frequencies that are sound frequencies to be absorbed.
   (2)
The sound-absorbing device according to (1), in which
resonance frequencies of the plurality of sound-absorbing parts are different from each other.
   (3)
The sound-absorbing device according to (1) or (2), in which
each of the plurality of sound-absorbing parts includes a neck portion and a cavity portion communicating with the neck portion.
   (4)
The sound-absorbing device according to (3), in which the neck portion includes a first opening portion serving as an open end and a second opening portion arranged in the cavity portion, and
the plurality of sound-absorbing parts differs in at least one of a diameter of the first opening portion, a diameter of the second opening portion, a length of the neck portion, or a cross-sectional shape of the neck portion.
   (5)
The sound-absorbing device according to any one of (1) to (4), in which
the plurality of sound-absorbing parts of each of the plurality of acoustic meta materials has a matrix arrangement.
   (6)
The sound-absorbing device according to any one of (1) to (5), in which
a sound absorption factor of the plurality of acoustic meta materials at the target frequencies is 0.8 or higher.
   (7)
A vehicle including:
a plurality of acoustic meta materials, in which
each of the plurality of acoustic meta materials includes a plurality of sound-absorbing parts, and
at least a first acoustic meta material and a second acoustic meta material out of the plurality of acoustic meta materials differ in target frequencies that are sound frequencies to be absorbed.
   (8)
The vehicle according to (7), in which
the plurality of acoustic meta materials are provided in a roof section.
   (9)
The vehicle according to (7) or (8), in which
the plurality of acoustic meta materials is provided at positions where an amplitude of a standing wave increases in a vehicle interior.
   (10)
The vehicle according to (7) or (8), in which
the plurality of acoustic meta materials is provided at positions corresponding to an arrival direction of noise propagating in the vehicle interior.
   (11)
The vehicle according to (10), in which
the plurality of acoustic meta materials is provided at positions to which the noise propagates in the vehicle interior.
   (12)
The vehicle according to (11), in which
an acoustic meta material having a target frequency according to an arrival direction, a frequency, and a sound pressure of the noise is provided.
   (12)
The vehicle according to (11), in which
the arrival direction of the noise and the frequency of the noise are an arrival direction and a frequency obtained by measurement.

### REFERENCE SIGNS LIST

1 Sound-absorbing device
10 Acoustic meta material
21 Sound-absorbing part
30, 50 Vehicle
31 Roof section
221 Neck portion
222 Cavity portion
223 First opening portion
224 Second opening portion

1. A sound-absorbing device comprising:
a plurality of acoustic meta materials, wherein
each of the plurality of acoustic meta materials includes a plurality of sound-absorbing parts, and
at least a first acoustic meta material and a second acoustic meta material out of the plurality of acoustic meta materials differ in target frequencies that are sound frequencies to be absorbed.

2. The sound-absorbing device according to claim 1, wherein
resonance frequencies of the plurality of sound-absorbing parts are different from each other.

3. The sound-absorbing device according to claim 1, wherein
each of the plurality of the sound-absorbing parts includes a neck portion and a cavity portion communicating with the neck portion.

4. The sound-absorbing device according to claim 3, wherein
the neck portion includes a first opening portion serving as an open end and a second opening portion arranged in the cavity portion, and
the plurality of sound-absorbing parts differs in at least one of a diameter of the first opening portion, a diameter of the second opening portion, a length of the neck portion, or a cross-sectional shape of the neck portion.

5. The sound-absorbing device according to claim 1, wherein
the plurality of sound-absorbing parts of each of the plurality of acoustic meta materials has a matrix arrangement.

6. The sound-absorbing device according to claim 1, wherein
a sound absorption factor of the plurality of acoustic meta materials at the target frequencies is 0.8 or higher.

7. A vehicle comprising:
a plurality of acoustic meta materials, wherein
each of the plurality of acoustic meta materials includes a plurality of sound-absorbing parts, and
at least a first acoustic meta material and a second acoustic meta material out of the plurality of acoustic meta materials differ in target frequencies that are sound frequencies to be absorbed.

8. The vehicle according to claim 7, wherein
the plurality of acoustic meta materials are provided in a roof section.

9. The vehicle according to claim 7, wherein
the plurality of acoustic meta materials is provided at positions where an amplitude of a standing wave increases in a vehicle interior.

10. The vehicle according to claim 7, wherein
the plurality of acoustic meta materials is provided at positions corresponding to an arrival direction of noise propagating in the vehicle interior.

11. The vehicle according to claim 10, wherein
the plurality of acoustic meta materials is provided at positions to which the noise propagates in the vehicle interior.

12. The vehicle according to claim 11, wherein
an acoustic meta material having a target frequency according to an arrival direction, a frequency, and a sound pressure of the noise is provided.

13. The vehicle according to claim 12, wherein
the arrival direction of the noise and the frequency of the noise are an arrival direction and a frequency obtained by measurement.
